(19) United States
(12) Patent Application Publication
(10) Pub. No.: US 2014/0379438 A1
(43) Pub. Date: Dec. 25, 2014

(54) INFORMATION PROCESSING APPARATUS, INFORMATION PROCESSING METHOD, AND COMPUTER-READABLE MEDIUM

(71) Applicant: FUJI XEROX Co., Ltd., Tokyo (JP)

(72) Inventors: Morihiro KAMEDA, Kanagawa (JP); Hirotaka ARAI, Kanagawa (JP); Kyoko AOYAMA, Kanagawa (JP); Masaki KYOJIMA, Kanagawa (JP); Kazuo SAITO, Kanagawa (JP)

(73) Assignee: FUJI XEROX Co., Ltd., Tokyo (JP)

(21) Appl. No.: 14/146,445

(22) Filed: Jan. 2, 2014

(30) Foreign Application Priority Data
Jun. 19, 2013 (JP) 2013-128769

(51) Int. Cl. G06Q 10/06

(52) U.S. Cl. CPC G06Q 10/06398
USPC 705/7.42

(57) ABSTRACT

An information processing apparatus includes a reference data acquisition unit acquiring reference data representing a reference work time for each of work processes, an area data acquisition unit acquiring area data representing an area on a medium having entry fields, each of which corresponds to one of the work processes and one of which is provided for the area, an entry data acquisition unit acquiring entry data representing stroke coordinates information representing a stroke made on the medium by a user, and a time when the writing was performed, a specifying unit specifying the entry field in which the user performed writing and the time when the writing was performed, a calculation unit calculating a work time required for each of the work processes, and an evaluation unit, for each of the work processes, comparing the reference work time with the work time and evaluating the work.

### CROSS-REFERENCE TO RELATED APPLICATIONS

This application is based on and claims priority under 35 USC 119 from Japanese Patent Application No. 2013-128769 filed Jun. 19, 2013.

### BACKGROUND

The present invention relates to an information processing apparatus, an information processing method, and a computer-readable medium.

### SUMMARY

An information processing apparatus according to an aspect of the present invention includes a reference data acquisition unit, an area data acquisition unit, an entry data acquisition unit, a specifying unit, a calculation unit, and an evaluation unit. The reference data acquisition unit acquires reference data representing a reference work time for each of multiple work processes. The area data acquisition unit acquires area data representing an area on a medium. The medium is a medium on which multiple entry fields are provided. Each of the entry fields corresponds to a work process of the work processes. The area is provided for an entry field of the entry fields. The entry data acquisition unit acquires entry data representing stroke coordinates information and a time. The stroke coordinates information represents a writing stroke made on the medium by a user using an electronic pen. The time indicates when the writing was performed. The specifying unit specifies the entry field in which the user performed writing and the time when the writing was performed, on the basis of the area data and the entry data acquired by the entry data acquisition unit. The calculation unit calculates a work time required for each of the work processes, on the basis of the specified entry field and time. For each of the work processes, the evaluation unit compares the reference work time represented by the reference data with the work time and evaluates work for the work process performed by the user, in accordance with the comparison result.

### BRIEF DESCRIPTION OF THE DRAWINGS

Exemplary embodiments of the present invention will be described in detail based on the following figures, wherein:

FIG. 1 is a diagram illustrating an exemplary overall configuration of a system;

FIG. 2 is a diagram for describing an encoded image;

FIG. 3 is a diagram illustrating an exemplary form image;

FIG. 4 is a diagram illustrating an exemplary hardware configuration of an information processing apparatus;

FIG. 5 is a diagram illustrating exemplary reference data;

FIG. 6 is a diagram illustrating exemplary corresponding data;

FIG. 7 is a diagram illustrating the configuration of an electronic pen;

FIG. 8 is a diagram illustrating an exemplary functional configuration of an information processing apparatus;

FIG. 9 is a diagram illustrating an exemplary screen displayed on a display unit;

FIG. 10 is a diagram illustrating an exemplary screen displayed on a display unit;

FIG. 11 is a diagram illustrating an exemplary screen displayed on a display unit;

FIG. 12 is a diagram illustrating an exemplary screen displayed on a display unit;

FIG. 13 is a diagram illustrating an exemplary form image;

FIG. 14 is a diagram for describing a method of calculating an actual work time;

FIG. 15 is a diagram illustrating an exemplary interruption/restart area;

FIG. 16 is a diagram illustrating an exemplary form image;

FIGS. 17A and 17B are diagrams illustrating an example described by a form image and a screen displayed on a display unit;

FIG. 18 is a diagram illustrating an exemplary overall configuration of a system; and

FIG. 19 is a diagram illustrating an exemplary form image.

### DETAILED DESCRIPTION

### Configuration

### System Configuration

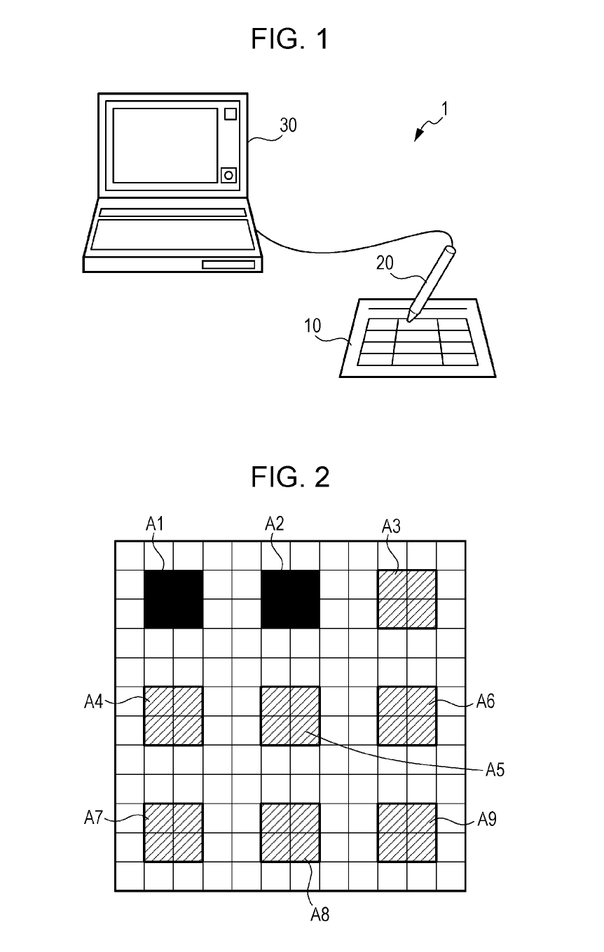

FIG. 1 is a diagram illustrating the overall configuration of a system 1 according to an exemplary embodiment of the present invention. The system 1 summarizes and manages work results of an inspection, such as checking of a vehicle or a plant and stocktaking. A worker carrying out an inspection writes his/her work results in a predetermined form. The system 1 summarizes the work results written by the worker, and evaluates and manages the results. As illustrated in FIG. 1, the system 1 roughly includes a medium 10, an electronic pen 20, and an information processing apparatus 30. The medium 10 is a medium, such as paper or an overhead projector (OHP) sheet. On the medium 10, an encoded image obtained in such a manner that position information representing a position on the medium 10 and identification information for identifying the medium 10 are encoded and imaged by using a predetermined encoding system is formed. In addition, on the medium 10, images of characters and tables representing the form format are also formed. These images are formed on the medium 10 by an image forming apparatus which forms an image, for example, by using an electrophotographic system.

The electronic pen 20 is a writing material used when a worker writes a work result on the medium 10. The electronic pen 20 has a function of allowing a worker to handwrite a character, a figure, or the like on the medium 10, and has a function of capturing the encoded image formed on the medium 10. The electronic pen 20 decodes the captured encoded image to obtain position information and identification information which are accumulated or output in chronological order. The information processing apparatus 30, which is an information processing apparatus such as a personal computer (PC), is connected to the electronic pen 20 through a cable such as a Universal Serial Bus (USB) cable. The information processing apparatus 30 uses the position information and the identification information decoded by the electronic pen 20 to summarize and manage the work results of the worker.

FIG. 2 is a diagram for describing an encoded image formed on the medium 10. As illustrated in FIG. 2, an encoded image is constituted by a group of dot images. In FIG. 2, rectangular areas A1 and A2 indicated in black correspond to an area in which dot images are disposed. Areas A3 to A9 indicated by using oblique lines correspond to an area in which no dot images are disposed. The encoded image represents identification information for identifying the medium 10 and position information representing a position on the medium 10, by using an arrange pattern of dot images.

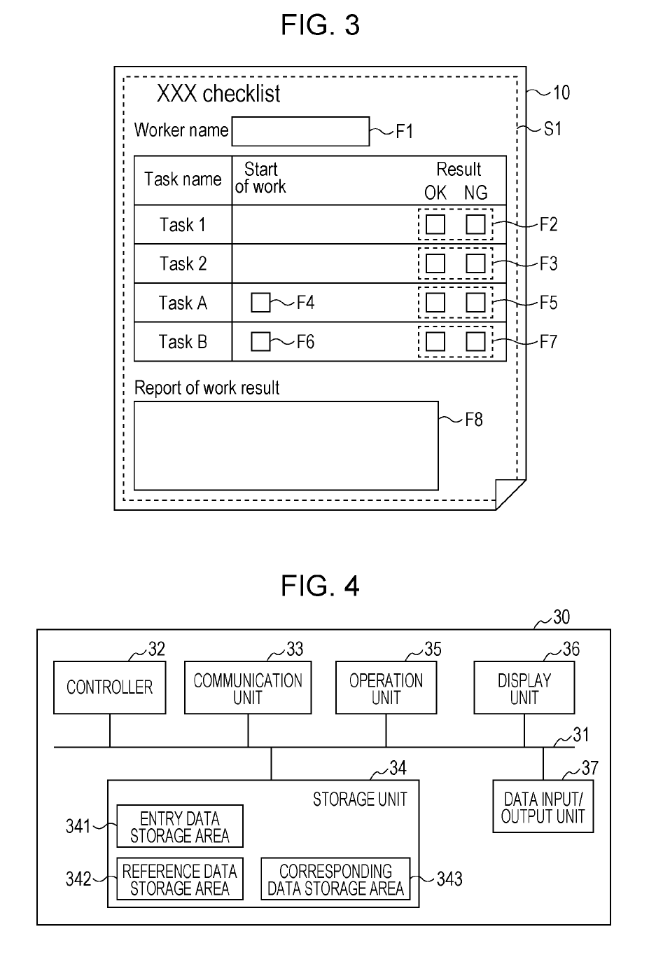

FIG. 3 is a diagram illustrating an exemplary form image (hereinafter, simply referred to as a “form”) formed on the medium 10. In the example illustrated in FIG. 3, a form S1 is illustrated in which four tasks, “task 1”, “task 2”, “task A”, and “task B”, are specified as work processes performed by a worker, and in which the worker writes work results of these work processes. For the tasks “task 1” and “task 2” among these work processes, a work result is to be written when the worker ends work. In contrast, for the tasks “task A” and “task B”, work results are to be written at the timing when the worker starts work and at the timing when the worker ends the work.

The form S1 includes areas (entry fields) F1 to F8 in which the worker writes characters or figures. The area F1 is an area in which a person name in charge of the work (i.e., worker name) is written. The area F2 is an area filled in by the worker when the worker ends the “task 1”. The area F3 is an area filled in by the worker when the worker ends the “task 2”. The area F4 is an area filled in by the worker when the worker starts the “task A”. The area F5 is an area filled in by the worker when the worker ends the “task A”. The area F6 is an area filled in by the worker when the worker starts the “task B”. The area F7 is an area filled in by the worker when the worker ends the “task B”. The area F8 is an area in which the worker writes a comment or the like about the work results.

### Hardware Configuration of Information Processing Apparatus 30

The hardware configuration of the information processing apparatus 30 will be described with reference to FIG. 4. FIG. 4 is a diagram illustrating an exemplary hardware configuration of the information processing apparatus 30. As illustrated in FIG. 4, the units of the information processing apparatus 30 which are connected to a bus 31 receive/transmit data from/to each other via the bus 31. In FIG. 4, a controller 32 includes an arithmetic and logic unit such as a central processing unit (CPU) and main storage units, such as a read only memory (ROM) and a random access memory (RAM). The arithmetic and logic unit uses a RAM as a work area to execute programs stored in a ROM or a storage unit 34, thereby controlling operations of the units of the information processing apparatus 30. A communication unit 33 communicates with other apparatuses. The storage unit 34 which is a storage device such as a hard disk stores data and programs used by the controller 32. An operation unit 35 which includes an operator such as a keyboard supplies an operation signal corresponding to a user operation to the controller 32. The controller 32 performs a process according to the operation signal. A display unit 36 which includes a liquid-crystal panel or a liquid-crystal driving circuit displays an image under the control of the controller 32. A data input/output unit 37 which is connected to a cable receives data which is output from the electronic pen 20.

The storage unit 34 includes an entry data storage area 341, a reference data storage area 342, and a corresponding data storage area 343. The entry data storage area 341 stores entry data that represents stroke coordinates information representing strokes of handwriting which was performed on the medium 10 by a user using the electronic pen 20 and that also represents a time when the writing was performed. The entry data generated in the electronic pen 20 in accordance with a writing operation is stored in the electronic pen 20, and is transmitted from the electronic pen 20 to the information processing apparatus 30 at a timing at which the electronic pen 20 is connected to the information processing apparatus 30 via the cable. The entry data includes position information representing a position on the medium 10 and identification information for identifying the medium 10. The entry data also includes time information representing a time when the writing was performed. The controller 32 stores the entry data obtained from the electronic pen 20 in the entry data storage area 341.

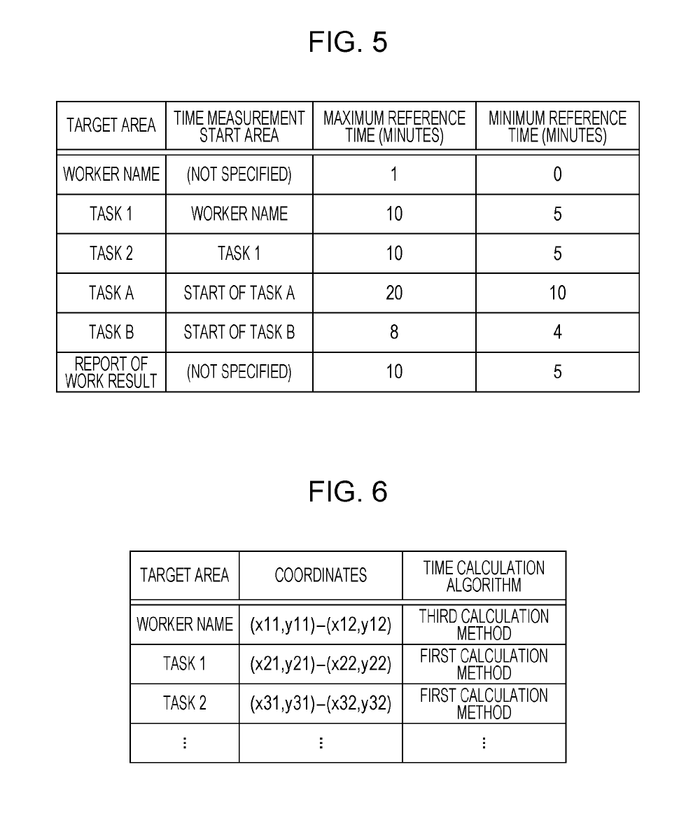

The reference data storage area 342 stores reference data representing times which function as reference for a work time required for each of the work processes. FIG. 5 is a diagram illustrating exemplary storage information in the reference data storage area 342. Data in items “target area”, “time measurement start area”, “maximum reference time (minutes)”, and “minimum reference time (minutes)” are stored in the reference data storage area 342 in such a manner as to be associated with each other. Among these items, the item “target area” stores identification information for identifying an area in the form (e.g., data representing the name of an area). The item “time measurement start area” stores identification information for identifying an area used to specify a start time of a work process corresponding to the item “target area” (e.g., data representing the area name). The item “time measurement start area” is referred to when the controller 32 calculates a work time of each of the work processes. The process of calculating a work time performed by the controller 32 will be described below, and is not described in detail here.

The item “maximum reference time (minutes)” stores the maximum value (minutes) which is regarded as an appropriate time required to perform a work process. The item “minimum reference time (minutes)” stores the minimum value (minutes) which is regarded as an appropriate time required to perform a work process. In the exemplary embodiment, the controller 32 determines whether or not the time required for the work process corresponding to identification information stored in the “target area” is within a range from the minimum value to the maximum value of the reference time, thereby determining whether or not the work in the work process is appropriate.

The corresponding data storage area 343 stores data representing a correspondence between each of the work processes and an area included in a form. FIG. 6 is a diagram illustrating exemplary storage information in the corresponding data storage area 343. Data in the items “target area”, “coordinates”, and the “time calculation algorithm” are stored in the corresponding data storage area 343 in such a manner as to be associated with each other. Among these items, the item “target area” stores identification information for identifying an area included in a form (e.g., data representing the name of an area). The item “coordinates” stores coordinates information representing each of the areas by using coordinates on the medium (exemplary area data). The item “time calculation algorithm” stores data representing the type of an algorithm used to calculate the work time of the work process corresponding to each of the areas. In the exemplary embodiment, three calculation methods, “first calculation method”, “second calculation method”, and “third calculation method”, are used as the “time calculation algorithm”. Each of the calculation methods will be described below, and is not described in detail here.

### Configuration of Electronic Pen 20

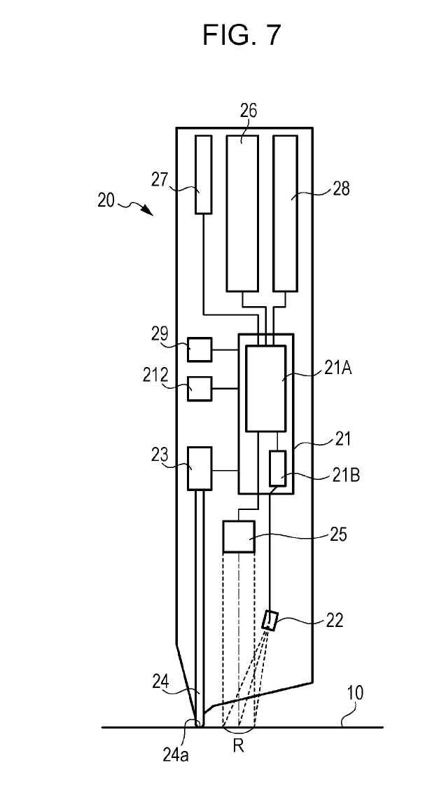

FIG. 7 is a diagram illustrating the configuration of the electronic pen 20. In FIG. 7, a controller 21 includes a signal processing circuit 21A and a driving circuit 21B. Other than these, the controller 21 has, for example, a configuration for managing the power of the electronic pen 20. The signal processing circuit 21A which includes an arithmetic and logic unit, such as a CPU or an application specific integrated circuit (ASIC), and a memory performs signal processing in the electronic pen 20. For example, the signal processing circuit 21A analyzes a captured image which is an image obtained by photographing the medium 10, decodes information represented by the encoded image, and extracts identification information and position information. The driving circuit 21B is a circuit for controlling driving of an irradiation unit 22, and, for example, controls the irradiation timing of light (herein, infrared light) emitted by the irradiation unit 22. The driving circuit 21B causes the irradiation unit 22 to irradiate an image capture area R on the medium 10 with light when a user performs a writing operation, under the control according to a result of detection performed by a pressure sensor 23. A timer 212 generates time information representing the current time, and outputs the generated time information. The pressure sensor 23 detects a writing operation performed by using the electronic pen 20, through a pressure (specifically, a writing pressure) applied to a refill 24. The refill 24 may be detachable from the electronic pen 20, and a pen point 24a is disposed on the tip of the refill 24. The pen point 24a indicates a position on the medium 10 on which an encoded image is formed, when a user performs a writing operation by using the electronic pen 20, and ejects ink to perform writing on the medium 10.

An image capture device 25 captures an image of reflected light generated when the infrared light emitted from the irradiation unit 22 is reflected off the medium 10. In the electronic pen 20, the image capture device 25 photographs the surface of the medium 10 at a predetermined frame rate, e.g., 60 frames per second (fps). An information memory 26 stores identification information and position information which are extracted by the signal processing circuit 21A and time information which is output from the timer 212. A data input/output unit 27 is an interface for receiving/transmitting data from/to the information processing apparatus 30. The data input/output unit 27 is connected to the cable, and outputs the identification information and the position information stored in the information memory 26, to the information processing apparatus 30 under the control of the controller 21. A battery 28 which is, for example, a battery charger supplies power for driving the electronic pen 20, to the units of the electronic pen 20. A pen ID memory 29 stores identification information of the electronic pen 20.

In the exemplary embodiment, when the pressure sensor 23 detects a writing pressure, the controller 21 starts reading identification information and position information, and obtains time information from the timer 212. Until the pressure detected by the pressure sensor 23 becomes equal to or less than a predetermined threshold, the controller 21 continues the reading of identification information and position information at predetermined time intervals. When the detected pressure becomes equal to or less than the predetermined threshold (that is, the pen point 24a leaves the medium 10), the controller 21 stores, in the information memory 26, a group of identification information and position information which are obtained from the start to the end of the reading of identification information and position information, and time information representing a start time of the reading of identification information and position information, as a group of data. In the description below, for convenience in description, a line drawn after the pressure sensor 23 detects a pressure until the pressure becomes equal to or less than the threshold, that is, a line drawn after a worker presses the pen point 24a of the electronic pen 20 on the medium 10 until the worker detaches the pen point 24a from the medium 10 is called a “stroke”. That is, the information memory 26 stores identification information and position information on a stroke-by-stroke basis, and also stores time information representing the start time for each of the strokes.

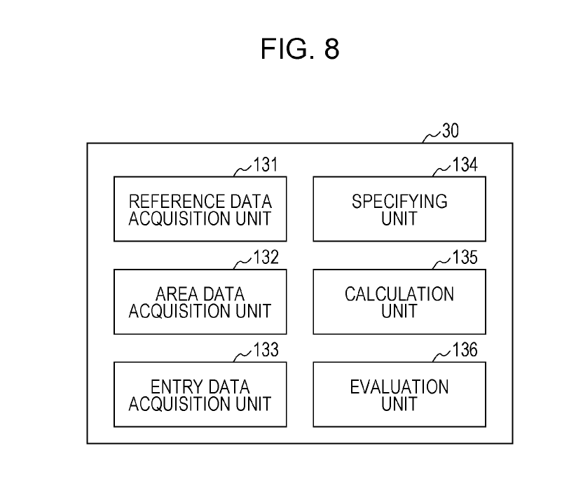

The functional configuration of the information processing apparatus 30 will be described with reference to FIG. 8. FIG. 8 is a diagram illustrating an exemplary functional configuration of the information processing apparatus 30. The information processing apparatus 30 uses the controller 32 or the controller 32 and the data input/output unit 37 to achieve a reference data acquisition unit 131, an area data acquisition unit 132, an entry data acquisition unit 133, a specifying unit 134, a calculation unit 135, and an evaluation unit 136. For each of the work processes, the reference data acquisition unit 131 obtains reference data representing a reference work time of the work process. The area data acquisition unit 132 obtains area data that is related to a medium on which entry fields are provided, and that represents an area which is on the medium and which corresponds to an entry field for each of the work processes among the entry fields.

The entry data acquisition unit 133 obtains entry data that represents stroke coordinates information representing a stroke of writing which was performed on a medium by a user using the electronic pen 20, and that also represents a time when the writing was performed. The specifying unit 134 specifies an entry field in which the user performed writing and a time when the writing was performed, on the basis of the area data and the entry data obtained by the entry data acquisition unit 133. The calculation unit 135 calculates a work time which was required for each of the work processes, on the basis of the result of the specification performed by the specifying unit 134. For each of the work processes, the evaluation unit 136 compares the reference work time represented by the reference data obtained by the reference data acquisition unit 131 with the work time calculated by the calculation unit 135, and evaluates the work in each of the work processes which was performed by the user, in accordance with the comparison result.

### Operation

### Presetting Operation

Operations according to the exemplary embodiment will be described. A manager sets reference times (maximum and minimum values) and the work order, for each of the areas in a form corresponding to work to be managed. Specifically, the manager uses the operation unit 35 to perform an operation for setting reference data values. The controller 32 causes the display unit 36 to display a list of reference data (e.g., a list illustrated in FIG. 5) in accordance with information which is output from the operation unit 35. The manager sets reference data values while watching the screen displayed on the display unit 36, and the controller 32 sets the reference data values in accordance with the information which is output from the operation unit 35. The manager may set the storage information in the corresponding data storage area 343 in addition to the storage information in the reference data storage area 342.

### Operation of Writing Work Result

Operations according to the exemplary embodiment will be described. Operations performed when a worker performs four work processes, “task 1”, “task 2”, “task A”, and “task B”, which correspond to the areas in the form S1 illustrated in FIG. 3, while filling in the form S1 will be described. In the exemplary embodiment, the medium 10 and the electronic pen 20 are prepared at a site in which the worker is to perform these tasks. In this situation, it is not necessary to connect the electronic pen 20 to the information processing apparatus 30 via a cable or the like. The worker uses the electronic pen 20 to write his/her name in the area F1 in the form S1. When writing using the electronic pen 20 is started, the pressure sensor 23 connected to the pen point 24a detects the writing operation. This causes the controller 21 to start reading identification information and position information. The controller 21 reads the encoded image formed on the medium 10, decodes codes represented by the read-out encoded image, and obtains identification information and position information. The read-out identification information and position information are accumulated in the information memory 26 on a stroke-by-stroke basis, along with time information which is output from the timer 212.

Upon completion of the writing in the area F1, the worker starts work of the “task 1”. After that, upon completion of the “task 1”, the worker writes the work result in the area F2. Specifically, if the work is successfully completed, the worker writes a check mark in the “OK” check box in the area F2. If the work is not successfully completed, the worker writes a check mark in the “NG” check box in the area F2. When writing is performed, the pressure sensor 23 connected to the pen point 24a of the electronic pen 20 detects the writing operation, and the controller 21 starts reading identification information and position information. The read-out identification information and position information are accumulated in the information memory 26 on a stroke-by-stroke basis, along with time information.

Upon completion of the writing in the area F2, the worker starts work of the “task 2”. After that, upon completion of the “task 2”, the worker writes the work result in the area F3. Specifically, if the work is successfully completed, the worker writes a check mark in the “OK” check box in the area F3. If the work is not successfully completed, the worker writes a check mark in the “NG” check box in the area F3. When writing is performed, the pressure sensor 23 connected to the pen point 24a of the electronic pen 20 detects the writing operation, and the controller 21 starts reading identification information and position information. The read-out identification information and position information are accumulated in the information memory 26 on a stroke-by-stroke basis, along with time information.

Upon completion of the writing in the area F3, the worker writes a check mark in the area F4, and then starts work of the “task A”. After that, upon completion of the “task A”, the worker writes the work result in the area F5. An operation for the area F5 is similar to those for the areas F2 and F3, and if the work is successfully completed, the worker writes a check mark in the “OK” check box in the area F5. If the work is not successfully completed, the worker writes a check mark in the “NG” check box in the area F5. When writing is performed, the pressure sensor 23 connected to the pen point 24a of the electronic pen 20 detects the writing operation, and the controller 21 starts reading identification information and position information. The read-out identification information and position information are accumulated in the information memory 26 on a stroke-by-stroke basis, along with time information.

Upon completion of the writing in the area F5, the worker writes a check mark in the area F6, thereby recording start of the “task B” in the form. After writing a check mark in the area F6, the worker starts work of the “task B”. After that, upon completion of the “task B”, the worker writes the work result in the area F7. An operation for the area F7 is similar to those for the areas F2, F3, and F5, and if the work is successfully completed, the worker writes a check mark in the “OK” check box in the area F7. If the work is not successfully completed, the worker writes a check mark in the “NG” check box in the area F7. When writing is performed, the pressure sensor 23 connected to the pen point 24a of the electronic pen 20 detects the writing operation, and the controller 21 starts reading identification information and position information. The read-out identification information and position information are accumulated in the information memory 26 on a stroke-by-stroke basis, along with time information.

Upon completion of the work of “task 1”, “task 2”, “task A”, and “task B”, the worker writes a comment or the like about the work results in the area F8. In response to the writing operation performed by the worker, the electronic pen 20 is used to read identification information and the position information which are accumulated in the information memory 26 along with time information. As described above, entry data that represents stokes which were written by the worker using the pen point 24a of the electronic pen 20 and that also represents times when the writing was performed is accumulated in the information memory 26.

### Operation of Evaluating Work

An operation in which the information processing apparatus 30 evaluates the work performed by a worker on the basis of the information written on the medium 10 will be described. When a manager connects the electronic pen 20 to the information processing apparatus 30 via the cable, the entry data stored in the information memory 26 is output to the information processing apparatus 30 under the control of the controller 21 of the electronic pen 20, in response to the connection. The controller 32 of the information processing apparatus 30 accumulates the entry data which is output from the electronic pen 20, in the entry data storage area 341.

The controller 32 evaluates the work processes on the basis of the entry data. This evaluation may be performed, for example, in response to an instruction to evaluate the work which is issued by the manager using the operation unit 35. Alternatively, this evaluation may be performed, for example, in response to the storing operation in which the entry data is stored in the entry data storage area 341. The controller 32 specifies an entry field in which the user performed the writing and a time when the writing was performed, on the basis of the data (area data) stored in the corresponding data storage area 343 and the entry data. In the exemplary embodiment, the controller 32 compares coordinates information indicated by the area data with stroke coordinates information included in the entry data, and specifies area data representing an area which includes stroke coordinates represented by the stroke coordinates information, thereby specifying the entry field.

In specification of a time when the writing was performed, in the exemplary embodiment, the controller 32 specifies the entry start time and the entry end time of each of the entry fields on the form. More specifically, the controller 32 determines in which entry field each stroke was written, on the basis of the position information for the stroke and the storage information of the corresponding data storage area 343. The controller 32 specifies the time information of the first stroke written in each entry field, as an entry start time of the entry field, and specifies the time information of the last stroke written in the entry field, as the entry end time of the entry field. Time information of a stroke is information representing a start time of the stroke. Therefore, the time information of the last stroke written in an entry field does not match the time when the writing in the entry field is completed. However, since a time required for each stroke is short, the time information representing the start time of the last stroke written in an entry field is used as information representing the entry end time of the entry field in the exemplary embodiment.

For each of the entry fields on the medium 10, the controller 32 calculates a work time which was required for the work process corresponding to the entry field. At that time, the controller 32 uses different calculation methods to calculate work times in accordance with predetermined information. In the exemplary embodiment, the controller 32 uses three calculation methods to calculate work times. The calculation methods will be described below.

A first calculation method will be described. This calculation method is used when work times of the “task 1” and the “task 2” in the example illustrated in FIG. 3 are calculated. In the calculation method, the difference between a time when writing was completed in the area corresponding to a work process to which a work order is specified, and a time when writing was completed in an area corresponding to the previous work process is calculated as a work time. Specifically, the controller 32 calculates a time period from a time when writing was completed in an area (hereinafter, referred to as a “previous area”) corresponding to the previous work process of the work process corresponding to an area (hereinafter, referred to as a “target area”) for which a work time is to be calculated, to a time when writing was completed in the target area, as a time required for the work. Specifically, for example, in the example in FIG. 3, the controller 32 calculates a time period from the time when writing was completed in the area F1 to the time when writing was completed in the area F2, as a work time of the “task 1”. The controller 32 calculates a time period from the time when writing was completed in the area F2 to the time when writing was completed in the area F3, as a work time of the “task 2”.

A second calculation method will be described. This calculation method is used when work times of the “task A” and the “task B” in the example illustrated in FIG. 3 are calculated. In the calculation method, the difference between times when writing was performed in two areas corresponding to a work process to which a work order is not specified is calculated as a work time. Specifically, the controller 32 calculates a time period from a time when writing was completed in an area predetermined as an area in which writing is to be performed when work is to start, to a time when writing was completed in an area predetermined as an area in which writing is to be performed when the work ends, as a time required for the work. Specifically, for example, in the example in FIG. 3, the controller 32 calculates a time period from the time when writing was completed in the area F4 to the time when writing was completed in the area F5, as a work time of the “task A”. The controller 32 calculates a time period from the time when writing was completed in the area F6 to the time when writing was completed in the area F7, as a work time of the “task B”.

A third calculation method will be described. This calculation method is used when work times for writing operations in the “worker name” and the “report of work result” in the example illustrated in FIG. 3 are calculated. In the calculation method, the controller 32 calculates a time period from the entry start time to the entry end time of one area, as a work time. Specifically, for example, in the example in FIG. 3, the controller 32 calculates a time period from the entry start time to the entry end time of the area F1 as a work time required for the writing operation in the “worker name”. The controller 32 calculates a time period from the entry start time to the entry end time of the area F8 as a work time required for the writing operation in the “report of work result”.

Upon completion of the calculation of a work time of each of the work processes, the controller 32 compares the calculated work time with the reference data stored in the reference data storage area 342, and evaluates the work process on the basis of the comparison result. In the exemplary embodiment, for each of the work processes, if the calculated work time is longer than the maximum reference time stored in the reference data storage area 342 or shorter than the minimum reference time, the controller 32 sets “NG” to the evaluation result. Otherwise, the controller 32 sets “OK” to the evaluation result. The controller 32 also determines whether or not the work order matches the order specified in the reference data. Upon completion of the evaluation of the work processes, the controller 32 stores evaluation data representing the evaluation result in the storage unit 34. At that time, the controller 32 adds identification information for identifying the medium 10, identification information for identifying the worker, time information representing a time when the entry data was obtained, a total work time, and information representing the overall evaluation result (e.g., when the results of all of the work processes are “OK”, “OK” is set; and when the result of any one of the work processes is “NG”, “NG” is set) to the evaluation data, and stores them in the storage unit 34.

### Operation of Displaying Evaluation Result

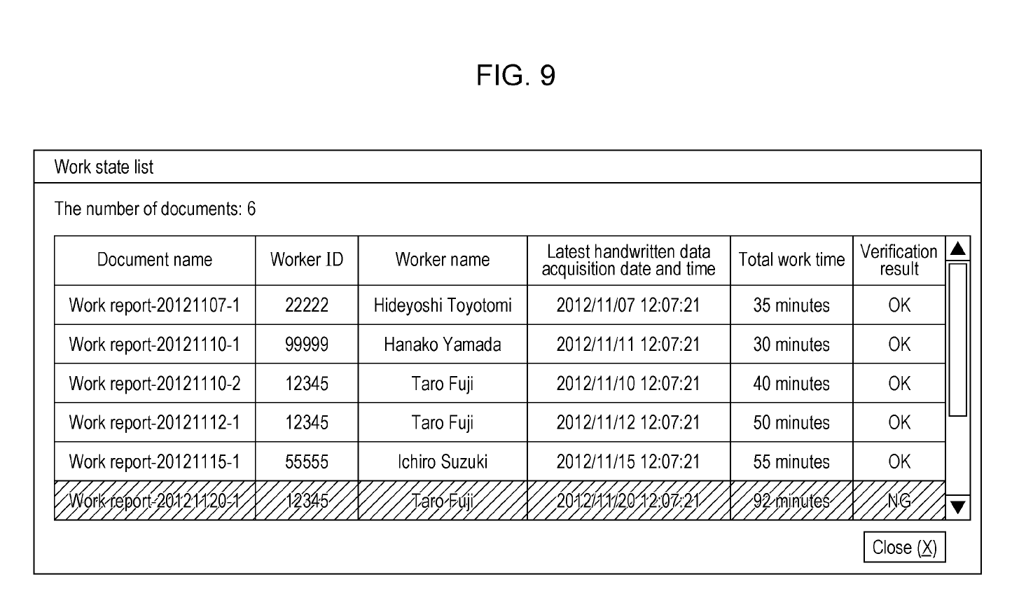

An operation of displaying the evaluation result will be described. The manager issues an instruction to display evaluation results, by using the operation unit 35. The controller 32 displays a list of evaluation results on the display unit 36 in accordance with information which is output from the operation unit 35. FIG. 9 is a diagram illustrating an exemplary screen displayed on the display unit 36. In the example in FIG. 9, a list of forms for which entry data was obtained is displayed. Specifically, records in which the items “document name”, “worker ID”, “worker name”, “latest handwritten data acquisition date and time”, “total work time”, and “verification result” are associated with each other are displayed on the display unit 36. In the item “document name”, the document name is displayed. In the item “worker ID”, identification information for identifying a worker is displayed. In the item “latest handwritten data acquisition date and time”, information representing a date and time when the entry data was obtained is displayed. In the item “total work time”, information representing the total time required for the work processes is displayed. In the item “verification result”, information representing the evaluation result for the work corresponding to the form is displayed. In the exemplary embodiment, when all of the evaluation results of the work processes included in the work corresponding to the form are “OK”, “OK” is displayed. When the evaluation results include a result which is “NG”, “NG” is displayed. In the example in FIG. 9, a line corresponding to a form whose evaluation result is NG is highlighted.

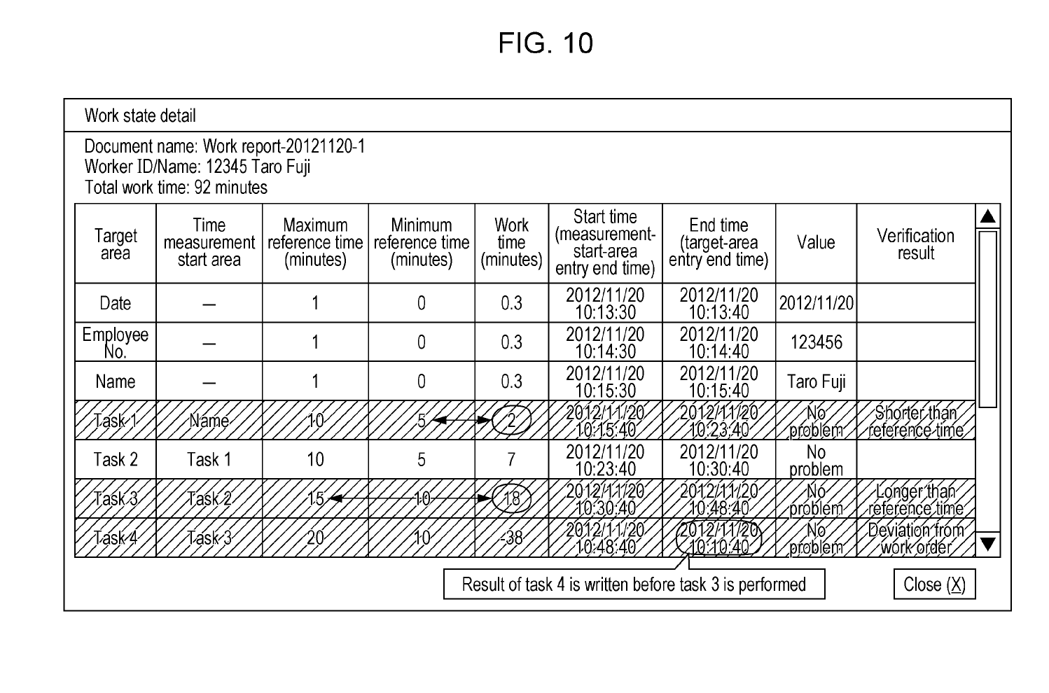

In the screen illustrated in FIG. 9, an operation of selecting any one of the records included in the displayed list is accepted. When the manager selects any one of the records, the controller 32 displays detailed information of the selected record as illustrated in FIG. 10 on the display unit 36. In the example in FIG. 10, detailed information is displayed for the areas included in the form corresponding to the selected record. Specifically, in the example in FIG. 10, records are displayed in which the items “target area”, “measurement start area”, “maximum reference time (minutes)”, “minimum reference time (minutes)”, “work time (minutes)”, “start time (measurement-start-area entry end time)”, “end time (target-area entry end time)”, “value”, and “verification result” are associated with each other. The items “target area”, “time measurement start area”, “maximum reference time (minutes)”, and “minimum reference time (minutes)” are similar to those described by using FIG. 5. In the item “work time (minutes)”, a work time calculated by the controller 32 is displayed. In the item “start time (measurement-start-area entry end time)”, a time specified as the start time of the work is displayed. In the item “end time (target-area entry end time)”, a time specified as the end time of the work is displayed. In the item “value”, data representing information written in the target area is displayed. If characters are written, the characters are displayed. If a predetermined figure or symbol such as a check mark is written, characters corresponding to the check box in the form (in this example, “no problem”) are displayed. In the item “verification result”, data representing the evaluation result generated by the controller 32 is displayed. At that time, if the calculated work time is longer than the maximum reference time, “longer than reference time” is displayed. If the calculated work time is shorter than the minimum reference time, “shorter than reference time” is displayed. If the work order does not match the order specified in the reference data, “deviation from work order” is displayed. Otherwise, nothing is displayed. In the screen illustrated in FIG. 10, the line corresponding to a target area whose verification result is NG is highlighted.

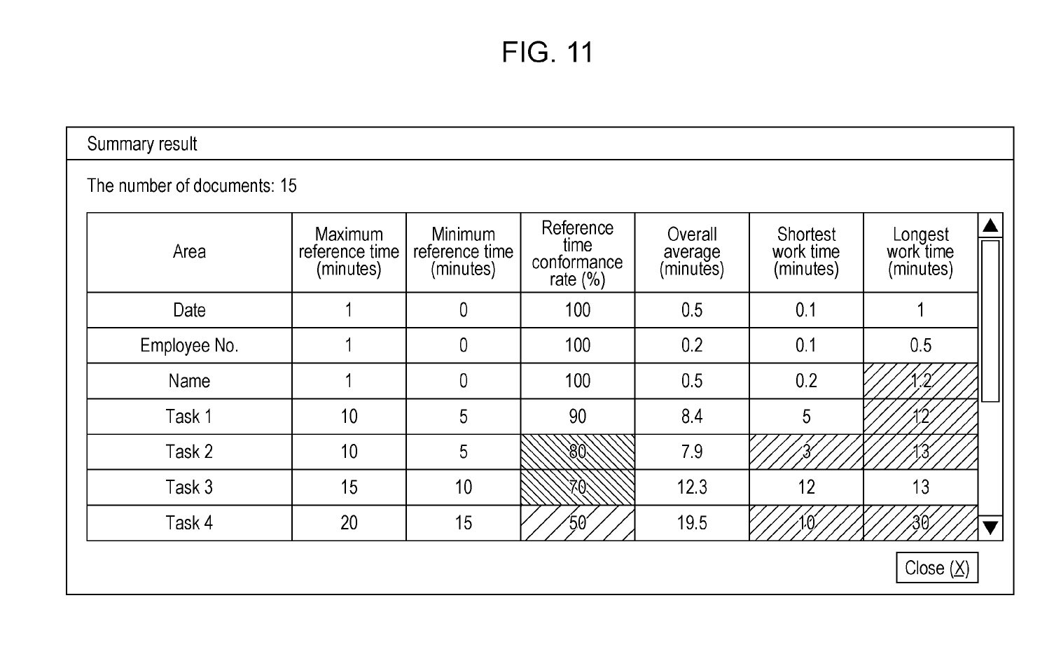

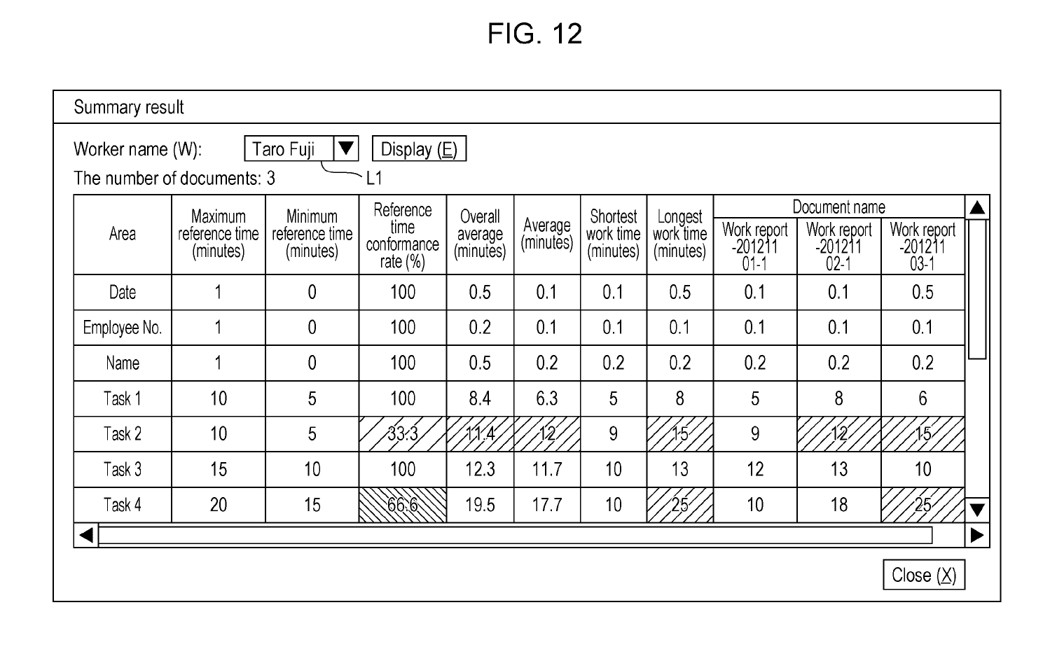

The controller 32 displays the summary of the work results in response to an operation performed by the manager. When the manager operates to issue an instruction to display the summary, by using the operation unit 35, the controller 32 displays a screen illustrated in FIG. 11 or 12, on the display unit 36 on the basis of information which is output from the operation unit 35. FIGS. 11 and 12 are diagrams illustrating an exemplary screen displayed on the display unit 36. FIG. 11 illustrates an exemplary display screen of the overall summary, and FIG. 12 illustrates an exemplary display screen of the summary for a worker. In the example in FIG. 11, records are displayed in which the items “area”, “maximum reference time (minutes)”, “minimum reference time (minutes)”, “reference time conformance rate (%)”, “overall average (minutes)”, “shortest work time (minutes)”, and “longest work time (minutes)” are associated with each other. In the item “area” among these items, data for identifying an area is displayed. In the item “maximum reference time (minutes)”, the maximum reference time for the area is displayed, and in the item “minimum reference time (minutes)”, the minimum reference time for the area is displayed. In the item “reference time conformance rate (%)”, a value representing a ratio of the number of forms whose evaluation result is OK to the number of forms used for the summary is displayed. In the item “overall average (minutes)”, the average of the work times for each area which is calculated by the controller 32 is displayed. In the item “shortest work time (minutes)”, the minimum value among the work times which is specified by the controller 32 is displayed. In the item “longest work time (minutes)”, the maximum value among the work times which is specified by the controller 32 is displayed.

In the screen illustrated in FIG. 11, a field corresponding to the target area whose verification result is NG is highlighted. Specifically, for example, in the item “reference time conformance rate (%)”, if the conformance rate in a field is equal to or less than 50%, the field may be displayed in red. If the conformance rate in a field is 51 to 89%, the field may be displayed in yellow. In the items “shortest work time (minutes)” and “longest work time (minutes)”, a field corresponding to an area whose work time is out of the range between the maximum and minimum reference times may be highlighted.

FIG. 12 illustrates the summary for a worker. In the example illustrated in FIG. 12, a list box L1 for selecting a person name in charge (worker name) is displayed, and records are displayed in which the items “area”, “maximum reference time (minutes)”, “minimum reference time (minutes)”, “reference time conformance rate (%)”, “overall average (minutes)”, “average (minutes)”, “shortest work time (minutes)”, “longest work time (minutes)”, and “document name” are associated with each other. Among these items, the items “area”, “maximum reference time (minutes)”, “minimum reference time (minutes)”, “reference time conformance rate (%)”, and “overall average (minutes)” are similar to those illustrated in FIG. 11. In the item “average (minutes)”, the average of the work times for the area which is calculated for the worker by the controller 32 is displayed. The items “shortest work time (minutes)” and “longest work time (minutes)” are similar to those illustrated in FIG. 11. In the item “document name”, a time calculated as a work time for each area in a work report (form) is displayed.

In the screen illustrated in FIG. 12, a field corresponding to the target area whose verification result is NG is highlighted. Specifically, for example, in the item “reference time conformance rate (%)”, if the conformance rate in a field is equal to or less than 50%, the field may be displayed in red. If the conformance rate in a field is 51 to 89%, the field may be displayed in yellow. In the items “shortest work time (minutes)”, “longest work time (minutes)”, and “document name”, a field corresponding to an area whose work time is out of the range between the maximum and minimum reference times may be highlighted.

In the case where a work result is simply written in a form, when a manager views the form, the manager may have difficulty in determining whether or not the work was appropriately done. Specifically, for example, the manager may fail to grasp whether or not a worker performed the work under a predetermined procedure, or may fail to grasp how long each task took. In contrast, in the exemplary embodiment, the information processing apparatus 30 evaluates work on the basis of, for example, times of writing in the areas in a form, and displays the evaluation result, facilitating manager's grasp of the work state simply through checking of the displayed screens.

In the case where the above-described first calculation method is used to calculate a work time, when the work was done under a wrong work order, the evaluation result will be NG. This facilitates determination as to whether or not the predetermined work order is used.

### Modified Exemplary Embodiment

The above-described exemplary embodiment is an example of the present invention, and may be modified as described below. In addition, the modified exemplary embodiments described below may be combined with each other.

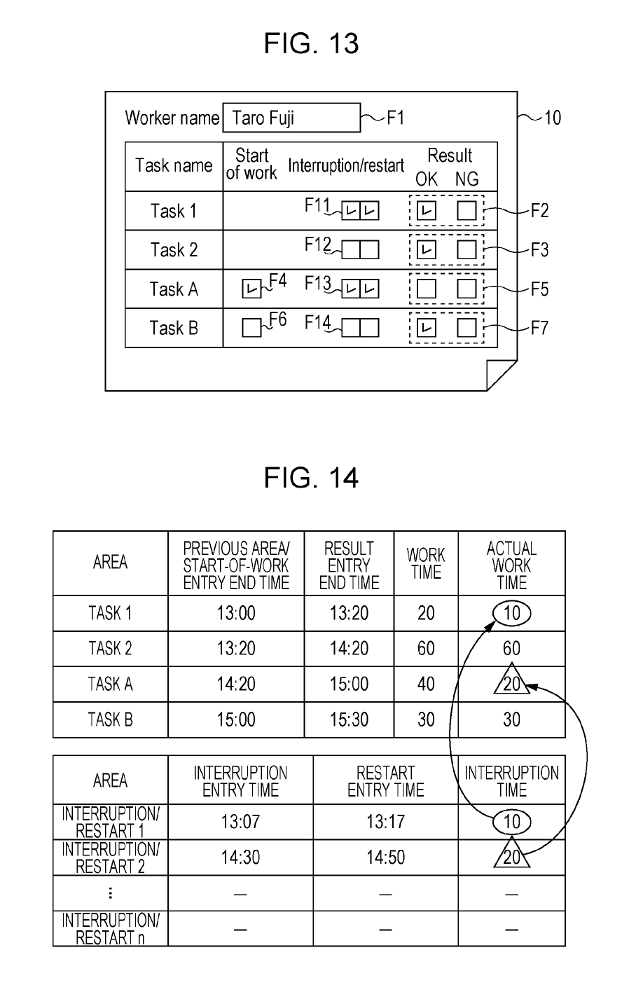

(1) In the above-described exemplary embodiment, in order to deal with a case where a worker takes an intermission during work, interruption/restart areas F11, F12, F13, and F14 may be provided on a form as illustrated in FIG. 13. A worker may fill in the areas, thereby recording an interrupted time. Specifically, in the example illustrated in FIG. 13, when a worker interrupts his/her work, the worker writes a check mark in the “interruption” check box in the interruption/restart area corresponding to the work. After that, when the work is to be restarted, the worker writes a check mark in the “restart” check box. In this case, when the controller 32 of the information processing apparatus 30 calculates the work time for each task on the basis of the entry data which is output from the electronic pen 20, the controller 32 calculates an interruption time from a time when writing was performed in the interruption area to a time when writing was performed in the restart area, and subtracts the calculated interruption time from the work time. Specifically, for example, if the start time, the end time, the interruption time, and the restart time for each task are those as illustrated in FIG. 14, for the “task 1”, the controller 32 subtracts the interruption time “10” from the time “20” calculated as a work time so as to calculate an actual work time. Similarly, for the “task A”, the controller 32 subtracts the interruption time “20” from the time “40” calculated as a work time so as to calculate an actual work time.

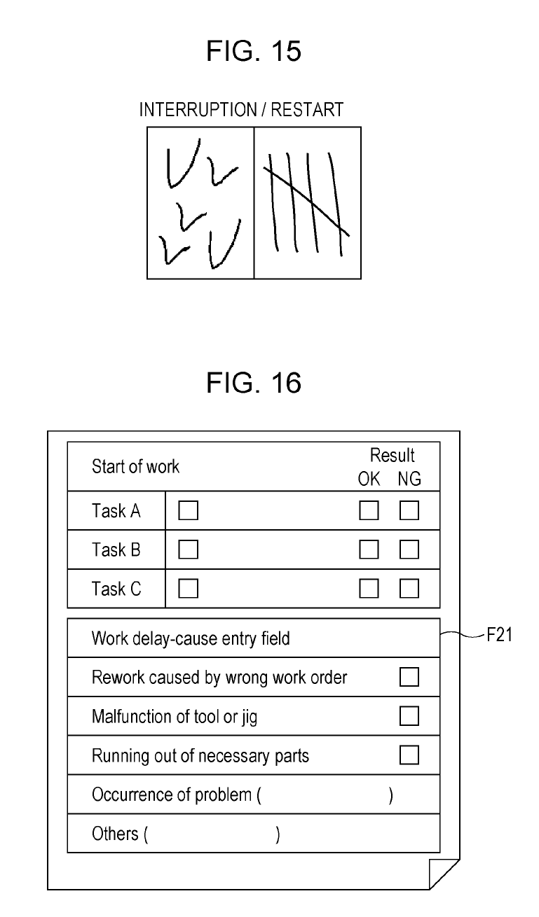

When a worker interrupts a task several times, for example, as illustrated in FIG. 15, a check mark may be written in the “interruption” check box for each of the interruptions. In this case, as illustrated in FIG. 15, check marks are written in the “interruption” check box. As illustrated in the “restart” check box in FIG. 15, one stroke may be written every time the worker restarts his/her work. In this case, the controller 32 sorts the entry start times of the strokes written in the “interruption” check box and the entry end times of the strokes written in the “restart” check box, in chronological order on the basis of the entry data which is output from the electronic pen 20, and calculates each of the interruption times. On the basis of the start times and the end times of the calculated interruption times, the controller 32 specifies a task in which each interruption was taken. Then, the controller 32 subtracts the calculated interruption time from the work time corresponding to the specified task so as to calculate an actual work time.

(2) In the above-described exemplary embodiment, as illustrated in FIG. 16, a delay-cause entry field F21 may be provided on a form so that, when a delay occurs in a task, a worker writes the reason. In this case, a manager checks a work-state detail screen or a summary-result display screen in the system, which facilitates check of the delay cause. A delay-cause entry field may be provided on the front side of a form, or may be provided, for example, on the back side or another sheet. In this case, the controller 32 of the information processing apparatus 30 specifies the entry time for each area included in a delay-cause entry field on the basis of the entry data which is output from the electronic pen 20, and specifies a corresponding task on the basis of the specified entry time. A delay cause may be written several times in one area. For example, in the case where a delay occurs in the “task A” and where another delay occurs in the “task B”, even when a worker fills in the same delay-cause entry field, the controller 32 specifies the pieces of writing as delay causes for the different tasks since the entry times are different.

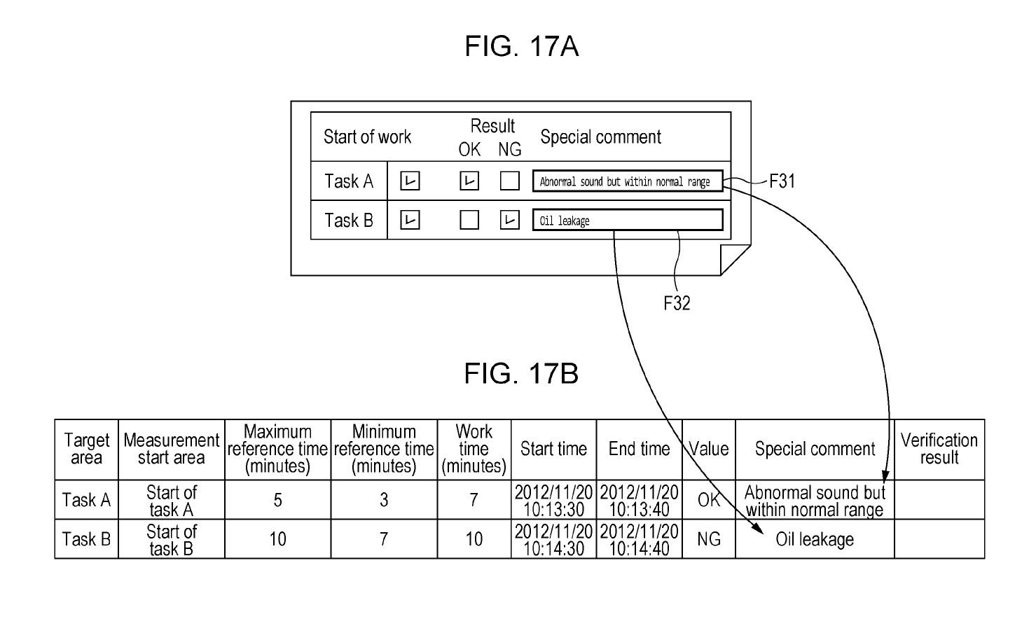

(3) In the above-described exemplary embodiment, in a work-state detail screen or a summary result display screen, a result of entry in an area (hereinafter, referred to as an “additional area”) accompanying the area corresponding to each work process may be displayed. FIG. 17A is a diagram illustrating an exemplary form image according to this aspect. FIG. 17B is a diagram illustrating an exemplary screen displayed on the display unit 36. As illustrated in FIG. 17A, additional areas F31 and F32 in which a special comment is to be written are provided for the areas corresponding to the work processes on a form. The controller 32 displays entry information in these area on the screen illustrated in FIG. 17B. A manager checks this screen to check the work results, which facilitates follow-up of the work. An additional area may accompany multiple areas corresponding to work processes.

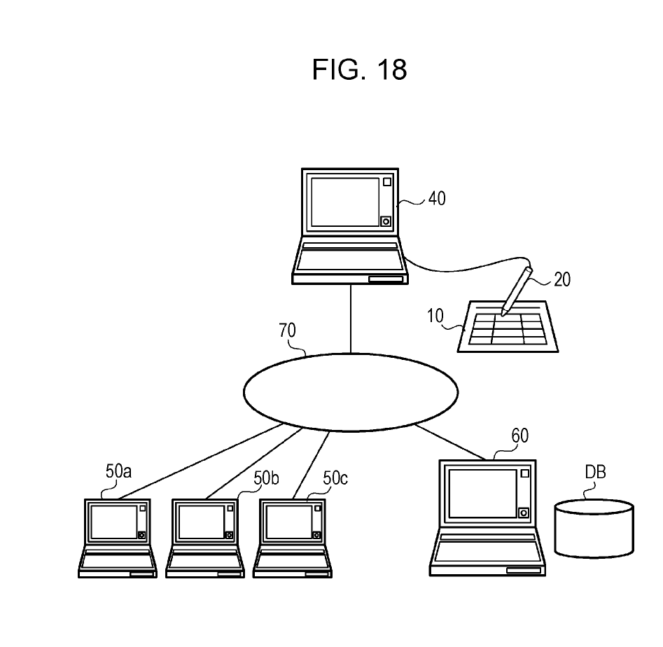

(4) In the above-described exemplary embodiment, the system configuration illustrated in FIG. 1 is described. However, the system configuration is not limited to that in FIG. 1, and another configuration may be employed. For example, the configuration illustrated in FIG. 18 may be employed. In the example in FIG. 18, a transmit terminal 40 that receives entry data which is output from the electronic pen 20 and that transmits the entry data, an administration terminal 60 that receives the entry data transmitted from the transmit terminal 40 and that evaluates work processes on the basis of the received entry data, and displays 50a, 50b, and 50c that display the evaluation result generated by the administration terminal 60 are connected to each other via a network 70. In this aspect, the administration terminal 60 includes a database DB storing the entry data, the reference data, the corresponding data according to the above-described exemplary embodiment.

The system configuration is not limited to this configuration, and another configuration may be employed. For example, the number of apparatuses included in the system may be different from that illustrated in FIG. 18. In the example in FIG. 18, the administration terminal 60 includes the database DB. Alternatively, the apparatus including the database DB may be an apparatus other than the administration terminal 60.

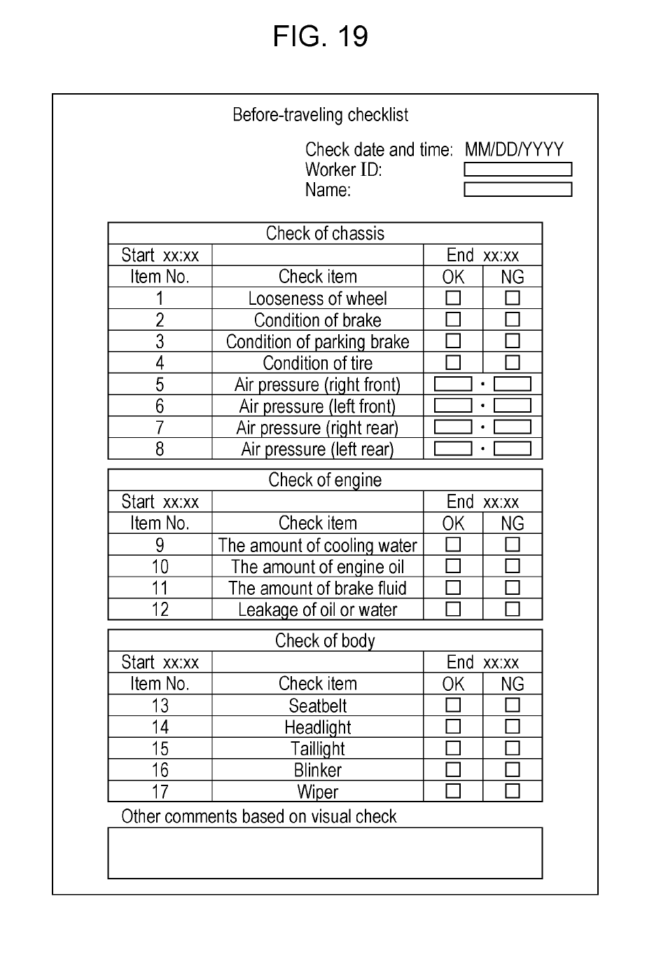

(5) In the above-described exemplary embodiment, the exemplary form illustrated in FIG. 3 is used as a form filled in by a worker. The form is not limited to that in FIG. 3. For example, an example illustrated in FIG. 19 may be used. In the form illustrated in FIG. 19, a manager predetermines the reference times for the areas. When a worker fills in the form, the controller 32 calculates a work time for each task on the basis of the entry data which is output from the electronic pen 20, and compares the calculated work time with a reference time so as to evaluate the work.

In the above-described exemplary embodiment, paper and an OHP sheet exemplify the medium 10. The medium 10 may be formed of other materials or have another configuration, such as electronic paper in which display information is electrically rewritten.

(6) In the above-described exemplary embodiment, the maximum and minimum reference times are used as reference data representing a reference time for a work time required for the work process corresponding to each of the areas. However, the aspect of setting a reference time is not limited to this. For example, one reference time is used. If a work time falls within the range from −10% to +10% of the reference time, the result may be OK. Otherwise, the result may be NG.

(7) In the above-described exemplary embodiment, the electronic pen 20 includes the timer 212. A configuration may be employed in which the electronic pen 20 does not include the timer 212. In this case, for example, the information processing apparatus 30 may include a timer, and position information and identification information which are read out by the electronic pen 20 from the medium 10 may be output to the information processing apparatus 30 in a real-time manner, and the information processing apparatus 30 may add time information to the position information and the identification information which are output from the electronic pen 20 so as to accumulate them as entry data.

In the above-described exemplary embodiment, the electronic pen 20 and the information processing apparatus 30 receive/transmit data from/to each other via wired connection. The electronic pen 20 and the information processing apparatus 30 may receive/transmit data from/to each other via wireless communication.

(8) In the above-described exemplary embodiment, a writing start time and a writing end time for each entry field are used as a time when writing was performed in the entry field. A time when writing was performed may be either of a writing start time and a writing end time. That is, a time when writing was performed may be a writing start time, a writing end time, or a median value of the writing start time and the writing end time.

In the above-described exemplary embodiment, the start time of each stroke is recorded as entry data. The start time and the end time of a stroke may be recorded. Instead of accumulation of data on a stroke-by-stroke basis, time information may be added at predetermined time intervals.

(9) Programs executed by the information processing apparatus 30 and the electronic pen 20 may be downloaded via a communication line such as the Internet. The programs may be provided by recording them in a computer-readable recording medium, such as a magnetic recording medium (e.g., a magnetic tape or a magnetic disk), an optical recording medium (e.g., an optical disk), a magneto-optic recording medium, or a semiconductor memory.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reference data acquisition unit that acquires reference data representing a reference work time for each of a plurality of work processes;
an area data acquisition unit that acquires area data representing an area on a medium, the medium being a medium on which a plurality of entry fields are provided, each of the plurality of entry fields corresponding to a work process of the plurality of work processes, the area being provided for an entry field of the plurality of entry fields;
an entry data acquisition unit that acquires entry data representing stroke coordinates information and a time, the stroke coordinates information representing a writing stroke made on the medium by a user using an electronic pen, the time indicating when the writing was performed;
a specifying unit that specifies the entry field in which the user performed writing and the time when the writing was performed, on the basis of the area data and the entry data acquired by the entry data acquisition unit;
a calculation unit that calculates a work time required for each of the plurality of work processes, on the basis of the specified entry field and time; and
an evaluation unit that, for each of the plurality of work processes, compares the reference work time represented by the reference data with the work time and that evaluates work for the work process performed by the user, in accordance with the comparison result.

2. The information processing apparatus according to claim 1,
wherein the area data has coordinates information representing the area for the entry field on the medium,
wherein the entry data acquisition unit acquires entry data representing stroke coordinates information and a time, the stroke coordinates information representing a writing stroke made on the medium by the user using the electronic pen, and
wherein the specifying unit specifies the entry field by comparing the coordinates information represented by the area data with the stroke coordinates information and by specifying the area data representing an area including stroke coordinates represented by the stroke coordinates information.

3. The information processing apparatus according to claim 1,
wherein the reference data represents an order in which two or more work processes among the plurality of work processes are to be performed,
wherein the specifying unit specifies a time when the user performed writing in an entry field corresponding to a target work process for which a previous work process is represented by the reference data, and also specifies a time when the user performed writing in an entry field corresponding to the previous work process, and
wherein the calculation unit calculates a time period as a work time required for the target work process, the time period being a period from the time which is specified by the specifying unit and which is when the writing for the previous work process was performed to the time which is specified by the specifying unit and which is when the writing for the target work process was performed.

4. The information processing apparatus according to claim 1,
wherein the specifying unit specifies at least one of a start time and an end time of the writing as the time when the writing was performed.

5. The information processing apparatus according to claim 2,
wherein the specifying unit specifies at least one of a start time and an end time of the writing as the time when the writing was performed.

6. The information processing apparatus according to claim 3,
wherein the specifying unit specifies at least one of a start time and an end time of the writing as the time when the writing was performed.

7. The information processing apparatus according to claim 1,
wherein the evaluation unit includes a display controller that extracts the work process whose work time calculated by the calculation unit does not match a reference work time represented by the reference data obtained by the reference data acquisition unit, and that exerts control so as to display the extracted work process whose work time does not match the reference work time, by using a predetermined display method.

8. The information processing apparatus according to claim 2,
wherein the evaluation unit includes a display controller that extracts the work process whose work time calculated by the calculation unit does not match a reference work time represented by the reference data obtained by the reference data acquisition unit, and that exerts control so as to display the extracted work process whose work time does not match the reference work time, by using a predetermined display method.

9. The information processing apparatus according to claim 3,
wherein the evaluation unit includes a display controller that extracts the work process whose work time calculated by the calculation unit does not match a reference work time represented by the reference data obtained by the reference data acquisition unit, and that exerts control so as to display the extracted work process whose work time does not match the reference work time, by using a predetermined display method.

10. The information processing apparatus according to claim 4,
wherein the evaluation unit includes a display controller that extracts the work process whose work time calculated by the calculation unit does not match a reference work time represented by the reference data obtained by the reference data acquisition unit, and that exerts control so as to display the extracted work process whose work time does not match the reference work time, by using a predetermined display method.

11. The information processing apparatus according to claim 5,
wherein the evaluation unit includes a display controller that extracts the work process whose work time calculated by the calculation unit does not match a reference work time represented by the reference data obtained by the reference data acquisition unit, and that exerts control so as to display the extracted work process whose work time does not match the reference work time, by using a predetermined display method.

12. The information processing apparatus according to claim 6,
wherein the evaluation unit includes a display controller that extracts the work process whose work time calculated by the calculation unit does not match a reference work time represented by the reference data obtained by the reference data acquisition unit, and that exerts control so as to display the extracted work process whose work time does not match the reference work time, by using a predetermined display method.

13. The information processing apparatus according to claim 1,
wherein the medium is a paper medium.

14. A non-transitory computer readable medium storing a program causing a computer to execute a process comprising:
acquiring reference data representing a reference work time for each of a plurality of work processes;
acquiring area data representing an area on a medium, the medium being a medium on which a plurality of entry fields are provided, each of the plurality of entry fields corresponding to a work process of the plurality of work processes, the area being provided for an entry field of the plurality of entry fields;
acquiring entry data representing stroke coordinates information and a time, the stroke coordinates information representing a writing stroke made on the medium by a user using an electronic pen, the time indicating when the writing was performed;
specifying the entry field in which the user performed writing and the time when the writing was performed, on the basis of the area data and the acquired entry data;
calculating a work time required for each of the plurality of work processes, on the basis of the specified entry field and time; and
for each of the plurality of work processes, comparing the reference work time represented by the reference data with the work time and evaluating work for the work process performed by the user, in accordance with the comparison result.

15. An information processing method comprising:
acquiring reference data representing a reference work time for each of a plurality of work processes;
acquiring area data representing an area on a medium, the medium being a medium on which a plurality of entry fields are provided, each of the plurality of entry fields corresponding to a work process of the plurality of work processes, the area being provided for an entry field of the plurality of entry fields;
acquiring entry data representing stroke coordinates information and a time, the stroke coordinates information representing a writing stroke made on the medium by a user using an electronic pen, the time indicating when the writing was performed;
specifying the entry field in which the user performed writing and the time when the writing was performed, on the basis of the area data and the acquired entry data;
calculating a work time required for each of the plurality of work processes, on the basis of the specified entry field and time; and
for each of the plurality of work processes, comparing the reference work time represented by the reference data with the work time and evaluating work for the work process performed by the user, in accordance with the comparison result.
